(19) United States
(12) Patent Application Publication
(10) Pub. No.: US 2004/0015491 A1
(43) Pub. Date: Jan. 22, 2004

(54) Method for enabling file format compatibility

(76) Inventors: Craig Matthew Brown, Carlingford NSW (AU); Timothy Merrick Long, Lindfield NSW (AU); Andrew James Dorrell, East Blaxland NSW (AU)

Correspondence Address: FITZPATRICK CELLA HARPER & SCINTO, 30 ROCKEFELLER PLAZA, NEW YORK, NY, 10112, US

(21) Appl. No.: 10/276,997

(22) PCT Filed: May 29, 2001
(86) PCT No.: PCT/AU01/00626

(30) Foreign Application Priority Data
May 29, 2000 (AU) PQ 7833
May 31, 2000 (AU) PQ 7863

(51) Int. Cl. G06F 7/00

(52) U.S. Cl. 707/3

(57) ABSTRACT

An expression which can be utilised to specify the functionality required for decoding and expanding a bitstream into image data is disclosed. The expression is preferably included in the overhead information for a bitstream. An image file structure is also disclosed. The file (800) comprises a number of elements (802 808) packed sequentially into a binary file.

Elements early in the file contain header information (802) (ie. Overhead information) which can include information identifying the file type as well as information describing parameters of the image data contained in the file (800).

### TECHNICAL FIELD OF THE INVENTION

The present invention relates to file formatting, and in particular, to a method and apparatus for encoding and decoding an electronic file to enable file format data to be provided in the file, to thereby aid a reader to determine whether the reader is compatible with the data in the file.

### BACKGROUND ART

Various methods are known to identify different types of files containing data for delivery over computer network systems and/or for storage on a particular computer. The method used to identify a particular file can typically be identfied by a file extension associated with the file. The Joint Photographics Expert Group (JPEG) and the Tagged Image File (TIF) standards use the file extensions “.jpg” and “.tif”, respectively, to identify image files. Another known method uses information within a file, referred to as a Macintosh™ Resource Fork which is binary data identifying the file.

The above mentioned methods have a number of disadvantages. For example, the file extension method used by some computer network systems is ignored on other systems leading to incompatibility between files. Further, in many situations, files identified as being the same can actually be differently configured. For example, the JPEG and TIF standards allow various options which not all file readers support. Still further, individual computer network systems determine which application should read a particular file depending on the identification, and quite often the application chosen is not capable of reading a file containing the specific options.

Some computer network systems attempt to index files using various indices to allow quick identification of the components used to configure the files. These various indices are not generic and while the indices may work in some applications, they are unsuitable for others. Further, the index is not always stored at the top of the file, and as such cannot be efficiently read. Still further, as new versions of the file format are created, the indices are changed, and again a generically compatible index system is not achieved.

Some file formats allow for the storage of multiple copies of data within a single file with each file being configured in a separate format. Such file formats allow a computer network system reading a file to decide which data to read depending on a particular environment, the capabilities of the file reader and the needs of the user. Systems using such a file format, list the various components of the file but not the details as to which combination of features is required to read a file.

One known system used to allow data to be transferred as the contents of electronic mail (e-mail) messages, referred to as the Multipurpose Internet Messaging Extensions (MIME) system, utilises a file wrapper to identify files. The MIME system also identifies files as a whole and not the options used within files.

Multi-layer (or multi-page) images can be thought of as a set of images, all typically but not necessarily the same size, which are somehow combined for the purpose of display. Thus, a multiple image (layer) file format refers to multiple images in a single file where each image in the file is referred to as a layer. The data used by a decoder to combine the layers of a multi-layer file invariably takes the form of a file format extension.

In accordance with the Graphics Interchange Format (GIF) standard, for example, an additional control structure called a graphics control extension is included in a file as a part of the information (ie. overhead information) that precedes each image layer. This information, amongst other things, includes the coordinates of the top left corner of the layer with respect to the total image area defined in the global file header and the amount of time to wait after displaying the layer before displaying the next layer in the file. The GIF also contains layers (or multiple images) which are composited in sequence order.

Each layer of a GIF file may be of different size and be positioned using offset coordinates in order to improve storage efficiency in cases where only small areas contain changes from one layer to the next. The GIF standard defines a virtual screen upon which each layer is composited. It uses a control block structure to indicate how the layers in the file are to be displayed. Each layer of the file format is preceded by a control block which contains, information about the location of the top left corner in the virtual screen, information on how long the layer should be displayed before proceeding to the next layer in the file, and whether the layer should be removed prior to display of a next layer in the file.

GIF has a simple and restricted design structure which makes it easy for a large number of independent developers to implement file viewers capable of handling GIF images. However, the simplicity of GIF comes at the price of efficiency in coding. For example, as each layer in a GIF file corresponds to a single image, sprites and overlays are not coded efficiently. This is because each frame must be present as a separate image layer. Images that are reused through the course of an image sequence must appear once in the file for each frame that the image appears in.

More recently, the “multiple Image” file formats have been developed, in an attempt to address the above problem. The multiple image file formats comprise multi-images in a single file with each image in the file being associated with at least one layer. One known multiple image (layer) file format defines an image framework based on extensions to the Portable Network Graphics (PNG) file format. However, the efficiency of encoding and decoding of the multiple image file formats is compromised by the requirement of description information for each layer in a particular file.

Summary of the Invention It is an object of the present invention to substantially overcome, or at least ameliorate, one or more disadvantages of existing arrangements.

According to a first aspect of the invention, there is provided an electronic file comprising:

encoded digital image data; and

an expression representing a plurality of boolean operations, wherein said expression identifies aspects of functionality needed to read said encoded digital image data.

According to another aspect of the invention, there is provided a method of encoding an electronic file containing at least one encoded digital image; said method comprising the steps of:

determining an expression for representing a plurality of boolean operations, wherein said expression identifies aspects of functionality needed to read said encoded digital image data; and

adding said expression in a support data area of said electronic file.

According to still another aspect of the invention, there is provided an apparatus for encoding an electronic file containing at least one encoded digital image, said apparatus comprising:

means for receiving an expression for representing a plurality of boolean operations, wherein said expression identifies aspects of functionality needed to read said encoded digital image data;

means for adding said expression in a support data area of said electronic file.

According to still another aspect of the invention, there is provided a computer readable medium having a program recorded thereon, said program comprising a plurality of software modules adapted for interactive operation on at least one computer platform, said program adapted to encode an electronic file containing at least one encoded digital image; said program comprising:

code for determining an expression for representing a plurality of boolean operations, wherein said expression identifies aspects of functionality needed to read said encoded digital image data; and

code for adding said expression in a support data area of said electronic file.

According to still another aspect of the invention, there is provided a method of encoding digital images in a coded representation, said method comprising the step of:

determining a description for each of said digital images in said coded representation; and

encoding said descriptions and said digital images as a bitstream, wherein at least one of said descriptions is sequentially associated with a plurality of said digital images.

According to still another aspect of the invention, there is provided a method of decoding a coded representation of digital images, each of said images having an associated description, said method comprising at least the step of:

outputting said digital images utilising said descriptions, wherein at least one of said descriptions is sequentially associated with a plurality of said digital images.

According to still another aspect of the invention, there is provided a method of encoding one or more digital images in a coded representation, said method comprising the steps of:

determining the number of digital images in said coded representation;

determining a description for each of said digital images in said coded representation;

comparing said descriptions of said digital images to determine a number of images with like descriptions;

determining an order of presentation of said digital images; and

encoding said set of descriptions and said digital images as a bitstream, wherein only one of said like descriptions are included in said bitstream and wherein those digital images with said like descriptions are placed sequentially at the end of said order.

According to still another aspect of the invention, there is provided a method of decoding a coded representation of one or more digital images, each of said images having an associated description, said method comprising the steps of:

determining the number of descriptions in said coded representation;

determining the number of digital images in said coded representation; and

outputting said descriptions and said digital images as a bitstream, wherein if said number of digital images is greater than said number of descriptions then a first number of said descriptions is sequentially associated with a second number of said digital images and a remaining one of said descriptions is associated with any remaining digital images.

According to still another aspect of the invention, there is provided a method of encoding digital images in a coded representation, said method comprising the step of:

determining a description for each of said digital images in said coded representation; and

encoding said descriptions and said digital images as a bitstream, wherein at least one of said descriptions is sequentially associated with a plurality of said digital images, and wherein said description comprises an indicator specifying the number of digital images with which said description is associated.

According to still another aspect of the invention, there is provided an apparatus for encoding digital images in a coded representation, said apparatus comprising:

means for determining a description for each of said digital images in said coded representation; and

means for encoding said descriptions and said digital images as a bitstream, wherein at least one of said descriptions is sequentially associated with a plurality of said digital images.

According to still another aspect of the invention, there is provided an apparatus for decoding a coded representation of digital images, each of said images having an associated description, said apparatus comprising:

means for outputting said digital images utilising said descriptions, wherein at least one of said descriptions is sequentially associated with a plurality of said digital images.

According to still another aspect of the invention, there is provided an apparatus for encoding one or more digital images in a coded representation, said apparatus comprising:

means for determining the number of digital images in said coded representation;

means for determining a description for each of said digital images in said coded representation;

means for comparing said descriptions of said digital images to determine a number of images with like descriptions;

means for determining an order of presentation of said digital images; and

means for encoding said set of descriptions and said digital images as a bitstream, wherein only one of said like descriptions are included in said bitstream and wherein those digital images with said like descriptions are placed sequentially at the end of said order.

According to still another aspect of the invention, there is provided an apparatus for decoding a coded representation of one or more digital images, each of said images having an associated description, said apparatus comprising:

means for determining the number of descriptions in said coded representation;

means for determining the number of digital images in said coded representation; and

means for outputting said descriptions and said digital images as a bitstream, wherein if said number of digital images is greater than said number of descriptions then a first number of said descriptions is sequentially associated with a second number of said digital images and a remaining one of said descriptions is associated with any remaining digital images.

According to still another aspect of the invention, there is provided an apparatus for encoding digital images in a coded representation, said apparatus:

means for determining a description for each of said digital images in said coded representation; and

means for encoding said descriptions and said digital images as a bitstream, wherein at least one of said descriptions is sequentially associated with a plurality of said digital images, and wherein said description comprises an indicator specifying the number of digital images with which said description is associated.

According to still another aspect of the invention, there is provided a computer readable medium having a program recorded thereon, said program comprising a plurality of software modules adapted for interactive operation on at least one computer platform, said program adapted to encode digital images in a coded representation, said program comprising:

code for determining a description for each of said digital images in said coded representation; and

code for encoding said descriptions and said digital images as a bitstream, wherein at least one of said descriptions is sequentially associated with a plurality of said digital images.

According to still another aspect of the invention, there is provided a computer readable medium having a program recorded thereon, said program comprising a plurality of software modules adapted for interactive operation on at least one computer platform, said program adapted to decode a coded representation of digital images, each of said images having an associated description, said program comprising:

code for outputting said digital images utilising said descriptions, wherein at least one of said descriptions is sequentially associated with a plurality of said digital images.

According to still another aspect of the invention, there is provided a computer readable medium having a program recorded thereon, said program comprising a plurality of software modules adapted for interactive operation on at least one computer platform, said program adapted to encode one or more digital images in a coded representation, said program comprising:

code for determining the number of digital images in said coded representation;

code for determining a description for each of said digital images in said coded representation;

code for comparing said descriptions of said digital images to determine a number of images with like descriptions;

code for determining an order of presentation of said digital images; and

code for encoding said set of descriptions and said digital images as a bitstream, wherein only one of said like descriptions are included in said bitstream and wherein those digital images with said like descriptions are placed sequentially at the end of said order.

According to still another aspect of the invention, there is provided a computer readable medium having a program recorded thereon, said program comprising a plurality of software modules adapted for interactive operation on at least one computer platform, said program adapted to decode a coded representation of one or more digital images, each of said images having an associated description, said program comprising:

code for determining the number of descriptions in said coded representation;

code for determining the number of digital images in said coded representation; and

code for outputting said descriptions and said digital images as a bitstream, wherein if said number of digital images is greater than said number of descriptions then a first number of said descriptions is sequentially associated with a second number of said digital images and a remaining one of said descriptions is associated with any remaining digital images.

According to still another aspect of the invention, there is provided a computer readable medium having a program recorded thereon, said program comprising a plurality of software modules adapted for interactive operation on at least one computer platform, said program adapted to encode digital images in a coded representation, said program comprising:

code for determining a description for each of said digital images in said coded representation; and

code for encoding said descriptions and said digital images as a bitstream, wherein at least one of said descriptions is sequentially associated with a plurality of said digital images, and wherein said description comprises an indicator specifying the number of digital images with which said description is associated.

According to still another aspect of the invention, there is provided an electronic file comprising:

encoded digital image data; and

an expression representing a plurality of boolean operations, wherein said expression defines a manner in which said encoded digital image data is to be read.

### BRIEF DESCRIPTION OF THE DRAWINGS

One or more embodiments of the present invention will now be described with reference to the drawings in which:

FIG. 1 is a flow chart showing a method for constructing a bit mask and a compatibility box;

FIG. 2 shows a mask table for an example functionality expression;

FIG. 3 shows another mask table for a further example functionality expression;

FIG. 4 shows a preferred format of the compatibility box;

FIG. 5 shows the mask table for yet another example functionality expression;

FIG. 6 is a flow chart showing a method for determining whether a file is compatible with a reader;

FIG. 7 is a schematic block diagram of a computer system upon which the arrangements described may be practiced;

FIG. 8 shows an image file structure;

FIG. 9 shows a further image file structure;

FIG. 10 shows the image file structure of FIG. 9, when a single layer file with single colour specification is being processed;

FIG. 11 is a flow chart showing a method of encoding digital images in a coded representation, in accordance with the file format of FIG. 8; and

FIG. 12 is a flowchart showing a method of encoding one or more images, in accordance with the file formats of FIGS. 8 and 9.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Image data is typically represented as a 2 dimensional array of values, where each of the values represents the attributes for a pixel to be rendered on a display screen. The attributes may represent the intensity of that pixel of the image in the case of a grey scale image, or the intensity of one colour component of that pixel. Colour images typically have several components being colour components (e.g. red, green and blue), a luminance component, and sometimes auxiliary components such as an opacity component. The representation of image data is therefore very dependent on the colour model used.

Images are typically encoded to form bitstreams, and one or more of these bitstreams can typically be combined with associated overhead information to form a codestream, which may then be used for storing and/or transmitting the image. The associated overhead information is the information required by a reader for decoding the bitstream(s) and expanding the bitstream(s) into image data.

An expression which can be utilised to specify the functionality required for decoding and expanding a bitstream into image data is described below. The expression is preferably included in the overhead information for a bitstream. Including a list of possible options within bitstream overhead information to specify the functionality required for decoding and expanding the bitstream would not suffice, due to the complexity in the different methods for coding and decoding colour models. Not only may bitstream(s) contain many different colour models, there are also numerous possible methods for coding the bitstream. The same image data may also be stored in the same file in many different ways. As an example, given an image data file containing motion frames, a decoder compatible with a first encoder as well as a first colour model to read the motion frames, where the decoder is also compatible with a second colour model to read a keyframe, a reader that understood a motion file using the coder, but did not understand the first colour model, could only display the keyframe.

An example of an expression which can be included in the overhead information for a file in order to specify the functionality required to read the file is as follows:

(A OR B) AND (C OR D) (1)

where each of the letters represent aspects of the required functionality. Therefore, to read the file, a reader needs to support functionality A or functionality B, as well as support either functionality C or functionality D.

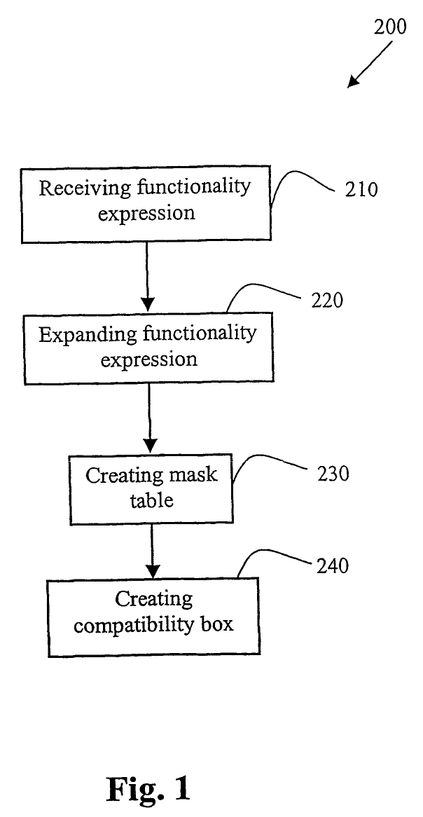

The above functionality expression is preferably represented using a bit mask and is encoded into a compatibility box. FIG. 1 is a flow chart 200 showing a method for constructing a bit mask and a compatibility box. The process of flow chart 200 begins at the first step 210, where a functionality expression is received as an input. At the next step 220, the functionality expression is expanded into a series of OR sub-expressions, separated by AND statements.

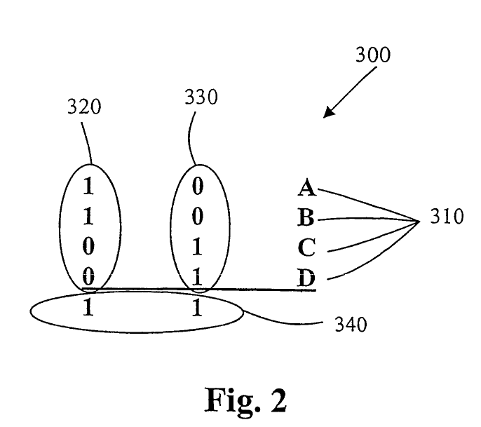

At the next step 230 a mask table is created, with each column of the table representing an aspect of the required functionality. The OR sub-expressions are placed in the columns of the mask table. FIG. 2 shows the mask table 300 for the functionality expression of Expression (1), where the mask table 300 has as rows the aspects of the required functionality 310 (ie. A, B, C and D). The columns 320 and 330 of the mask table 300 each represent one of the OR sub-expressions. The first OR sub-expression (i.e. A OR B) is placed in column 320 by representing each of the aspects present in the OR sub-expression by a 1 bit and the rest with a 0 bit. Therefore, because only aspects A and B are present in the OR sub-expression (A OR B), the column 320 has as an entry the bit string “1100”. In a similar manner the second OR sub-expression (C OR D) is placed in column 330 by the entry “0011”.

A required mask row 340 is also provided containing the result of performing the bitwise OR operator to all the rows in the mask table 300 that are required to read the file. In accordance with the example of FIG. 2, the bitwise OR operator is performed on the entries of rows 310, namely 10OR10OR01OR01, to create the required mask as 11.

An example of a more complex functionality expression is as follows:

(A AND B) OR (C AND D) (2)

Expression (2) indicates that a reader must either support functionality aspects A and B, or alternatively functionality aspects C and D.

Expression (2) is not in the specified format (i.e. a series of OR sub-expressions, separated by AND statements), and is therefore expanded at step 220 to give the following form:

(A AND B) OR (C AND D)=(A OR C) AND (A OR D) AND (B OR C) AND (B OR D) (3)

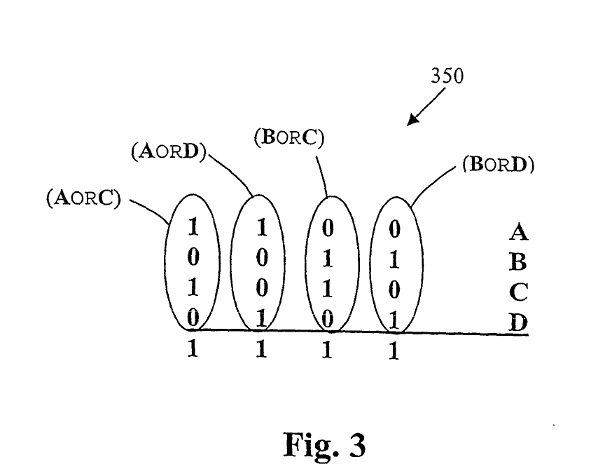

At the next step 230 a mask 350 is created as shown in FIG. 3. Each of the OR sub-expressions of the mask 350 are placed in respective columns with a 1 bit in a column if the aspect of required functionality is present in the OR sub-expression. Since there are four OR sub-expressions in the expanded expression, the mask 350 has four columns. The required mask entry is 1111.

At the next step 240 of the flow chart 200, the compatibility box is created from the mask table for specifying information about the functionality required for accessing the file. This functionality may be vendor specific or may be defined by a recognised standard. The compatibility box is placed near the beginning of the file, thereby enabling a reader to quickly determine if the file can be interpreted. The compatibility information can specify that a reduced set of aspects of required functionality is suitable to interpret part(s) of the file. For example, the information in the compatibility box can specify that a still image reader would be suitable to display a still version of an animated file.

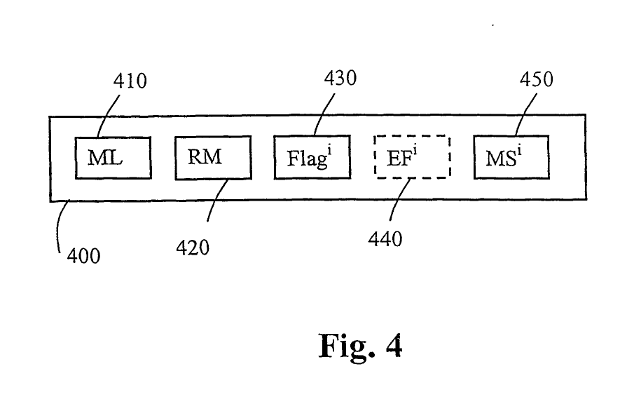

FIG. 4 shows a preferred format for a compatibility box 400, which includes an ML field 410, an RM field 420, Flagⁱ fields, EFⁱ fields 430 and MSⁱ fields. These fields are defined as follows:

ML: This field is a byte that specifies the number of bytes used for compatibility masks, and includes the required mask together with masks for each of the aspects of required functionality. Valid values are 1, 2, 4 and 8.

RM: This field specifies the required mask.

Flagⁱ: This field provides a compatibility flag informing the reader of the meaning of each aspect of required functionality. There are two types of compatibility flags being “standard” flags and “extended” flags. A single byte can be used to store standard flags, and a 64 bit Universal Unique Identifier (UUID) can be used to specify extended flags. The Flagⁱ field is a single byte that specifies that a standard flag is used for representing the aspect of required functionality. However, if the top bit of the field is set, then the rest of the field becomes the top order byte of a UUID extended flag.

EFⁱ: This is an optional field representing the low order 15 bytes of the UUID extended flag.

MSⁱ: This field specifies the mask for the aspect of required functionality.

The compatibility box thus has the following fields, each having specified sizes and possible values as shown in Table 1 below:

TABLE 1

| Field Name | Size (bits) | Value(s) |
|---|---|---|
| ML | 8 | 1, 2, 4, 8 |
| RM | 8 | 1, 2, 4, 8 |
| Flag¹ | 8 | 0-127 |
| EF¹ | 128 (including Flag) | 2¹²⁷-(2¹²⁸ − 1) |
| MS¹ | 8 | 1, 2, 4, 8 |

Further information can be specified in a file linking the UUID to a URL that specifies more information about the UUID.

The following tables (i.e. Tables 2, 3 and 4) list the preferred compatibility flags. The tables are grouped as Codestream flags, Colour flags and Metadata flags.

TABLE 2
Codestream Flags

| Flag | Description |
|---|---|
| 1 | Codestream Index |
| 2 | Multiple codestreams |
| 3 | Single codestream |
| 4 | Fragmented codestreams |
| 5 | Compression scheme X |
| 6 | Compression scheme Y |

TABLE 3
Colour Flags

| Flag | Description |
|---|---|
| 16 | sRGB Colour model |
| 17 | Restricted ICC Profile |
| 18 | Full ICC Profile |
| 19 | Palletized Colour |

TABLE 4
Metadata Flags

| Flag | Notes |
|---|---|
| 64 | Intellectual Property Rights Information |
| 65 | Content Description |
| 66 | Creation Information |
| 67 | History Information |

With many standard file formats (e.g. JPEG 2000) no extended flags are specified, but provision is made for vendors to create their own compatibility flags using a UUID. For example, if a vendor wishes to specify their own vendor specific colour model, then this colour model is identified using a UUID. Preferably, a single UUID is used throughout the file to specify the new colour model.

As an example, a compatibility box for a file containing a single compressed codestream, both a restricted ICC profile colour model and an sRGB colour model, and metadata containing Intellectual Property Rights Information, can be constructed using the method of flow chart 200 as follows:

At step 210, the compatibility information of the file is entered as an expression. From the above information, a suitable functionality expression is:

(A AND B AND C AND E) OR (A AND B ANDD AND E) (4)

where A represents a single codestream, B represents a compression scheme X codestream, C represents an sRGB Colour model, D represents a Restricted ICC Profile and E represents metadata containing Intellectual Property Rights Information.

At the next step 220, the functionality expression of Expression (4) is expanded into a series of OR sub-expressions, separated by AND statements as follows:

A AND B AND (C OR D) AND E (5)

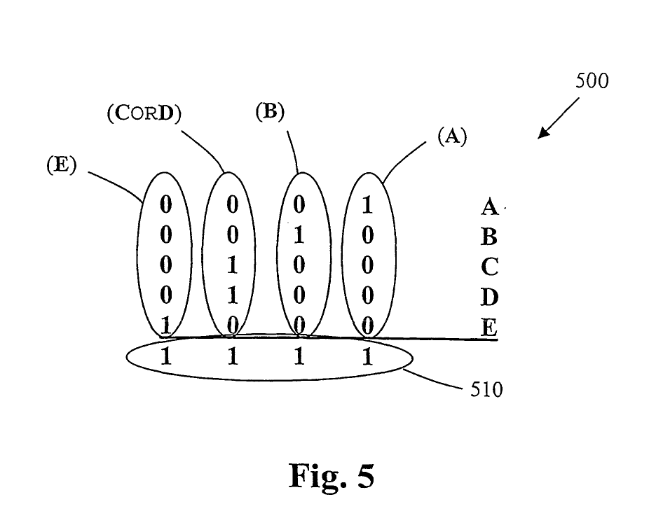

At the next step 230, a mask table 500 is created as shown in FIG. 5, for the functionality expression of Expression (5). Each row of the table 500 represents an aspect of the required functionality. There are five aspects of the required functionality, represented by A, B, C, D and E respectively. The OR sub-expressions are placed in the columns of the mask table 500. It is noted that most of the OR sub-expressions for the Expression (5) do not contain actual OR operators, but are identified through their separation by the AND operators.

The required mask column 510 contains the result of performing the OR operator on all of the rows. In accordance with the example of FIG. 5, the OR operator is performed as follows:

0001 OR 0010 OR 0100 OR 0100 OR 1000=1111 (6)

At the next step 240, the compatibility box is created from the mask table 500 as follows. The ML field entry is chosen as 1, allowing 1 byte to be used for the compatibility masks. The RM field entry is simply the row 510 with 0 bits added to fill the number of bytes specified by the ML field. The RM field entry is thus 00001111 or decimal 15.

The compatibility flags and their respective masks can then be defined. All the compatibility flags are standard flags and each is thus represented by a single byte. Looking up each of the aspects of required functionality from the compatibility flags table, the respective compatibility flags for the example are specified as follows:

| | |
|---|---|
| Single codestream | 3; |
| Compression scheme X codestream | 5; |
| sRGB Colour model | 16; |
| Restricted ICC Profile | 17; and |
| Metadata containing Intellectual Property Rights Information | 64. |

As only the standard flags are used, no EFⁱ fields are present. Finally, for each of the aspects of required functionality, the mask MSⁱ is determined. These masks MSⁱ are essentially the rows of the mask table 500 (disregarding the required mask row 510), with 0 bits added to fill the number of bytes specified by the ML field.

In summary, the compatibility box for the example is specified as follows:

| | |
|---|---|
| ML = 1 | |
| RM = 0000 1111 | |
| Flag¹ = 3 | MS¹ = 0000 0001 |
| Flag² = 5 | MS² = 0000 0010 |
| Flag³ = 16 | MS³ = 0000 0100 |
| Flag⁴ = 17 | MS⁴ = 0000 0100 |
| Flag⁵ = 64 | MS⁵ = 0000 1000 |

The compatibility box can be included in the overhead information of the file as a HEX string by combining the various fields as:

“0×010F03010502100411044008” (7)

The compatibility box for the example specifies that the reader must understand a single compression scheme X codestream and that either an SRGB colour model or restricted ICC is required. It also specifies that the sRGB colour model and the restricted ICC profile provide identical functionality.

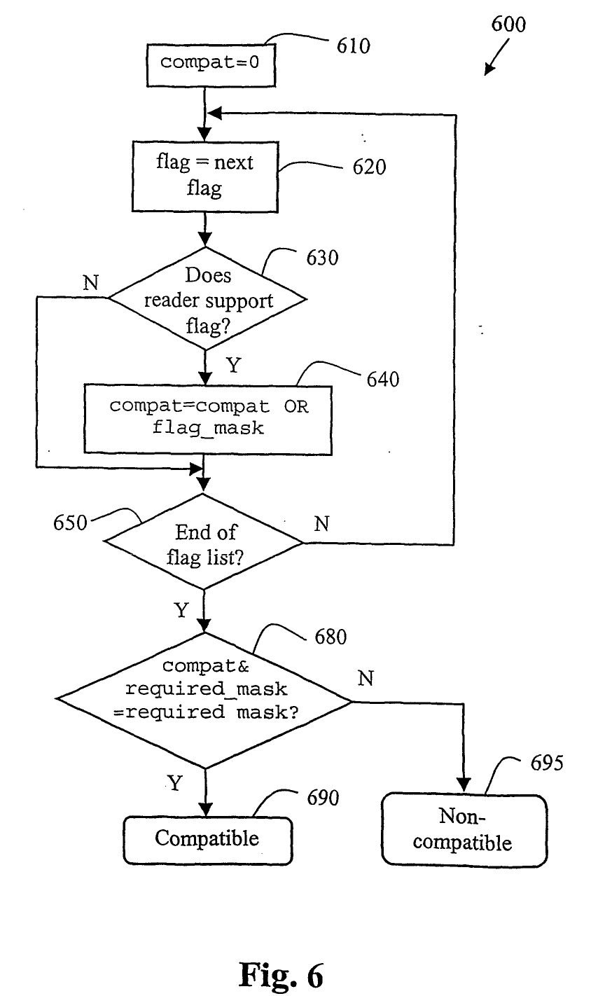

FIG. 6 is a flow chart 600 showing a method for determining whether a file is compatible with a particular reader. The file contains the compatibility box, which in turn contains a list of flags and flag masks as specified above. At the first step 610, a variable compat is set to 0. At the next step 620, a variable f lag is assigned the value of the next flag from the list of flags contained within the compatibility box of the file.

The process of flow chart 600 continues at the next step 630, where it is determined whether the flag (Plagi) is supported by the reader. If the flag is supported, then a bitwise OR operation between the variable compat and the mask is performed at the next step 640 for the aspect of required functionality that corresponds with the flag. For example, if the flag is Flag³, then the flag_mask is the mask MS³=0000 0100. The result of this bitwise OR operation is assigned as the new value for the variable compat. If the flag is not supported by the reader at step 630, then the process of flow chart 600 continues to step 650 where it is determined whether there are any remaining flags in the list of flags described in the compatibility box. If flags remain at step 650, then the process returns to step 620 where a next flag is read.

Alternatively, if all the flags contained in the compatibility box have been considered at step 650, then the process of flow chart 600 continues to step 680 where a bitwise AND operation is performed between the variable compat and the value of the required mask field in the compatibility box. The result of this operation is compared with the required mask field in the compatibility box. If the values correspond, then compatibility is reported at step 690. Alternatively, the file is reported as not compatible with the reader at step 695, and the file is not opened.

The above described methods allow a reader to not only determine whether a given file can be read, but also which aspects of functionality within the file should be read. The methods also allow the reader to understand all compatible files created in the future, so that future readers can read current files that are compatible. This is possible since each file specifies which functionality it provides, rather than relying on the reader to determine the same.

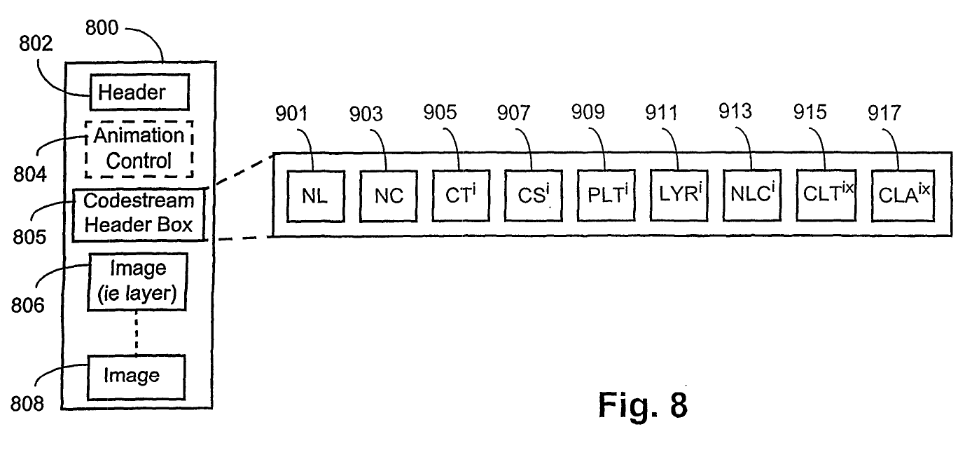

FIG. 8 shows an image file structure in accordance with another aspect of the present invention. The file 800 comprises a number of elements 802-808 packed sequentially into a binary file. Elements early in the file contain header information 802 (ie. overhead information) which can include information identifying the file type as well as information describing parameters of the image data contained in the file 800.

The file 800 preferably contains a codestream header box 805, which lists the type and channel information stored in each of one or more elements containing image data 806-808 or references to image data. The codestream header box 805 will be described in more detail later in this document.

There can be several distinct still images 806-808 contained or referenced in a file and each of these is referred to as a layer, as described above. Some of these layers may be visually incomplete when viewed separately as they are intended to be overlayed on or otherwise combined with other image layers in the file for display purposes. Each layer is however a complete codestream or set of codestreams, capable of being independently decoded and each layer is considered to be distinct within the scope of this description. Animation can be performed using one or more of the image layers 806-808, alone or in combination. In this instance, the file 800 comprises an animation control block 804, which contains animation control information.

Each image layer (eg. 806) comprises one or more channels which can be present as one or more codestreams contained in the file 800, or referenced by the file or derived by mapping image elements through a lookup table. Each codestream or reference contained in the file 800 is present in one or more file elements. Information in header elements is used by a file reader to recover the complete codestreams and decode those into image layers. For example, as described above, the information in the header elements can include Codestream Flags (e.g. codestream index, number of codestreams, type of codestream), color flags (e.g. sRGB colour space, restricted ICC profile, palettized colour) and Metadata Flags (e.g. Intellectual Property Rights Information, content description, creation information and history information).

The channels of each layer (eg. 806) comprise arrays of pixel values. These may correspond to samples of colour information specific to a colour space, which is defined within header elements 802 of the file 800. A single channel can also correspond to intensity samples as in a greyscale image. One or more channels can also contain samples of opacity information for use in rendering other channels in the layer. This channel is commonly referred to as the alpha channel. Alpha channel data can be binary (or bi-level) with each sample taking on only one of two possible values corresponding to fully transparent and fully opaque. Binary alpha data may be encoded with the colour channels by assigning a unique colour to all pixels which are fully transparent.

A method of encoding digital images into a file format in accordance with FIG. 8 (i.e. a coded representation) represented by the file 800 is described below. The file 800 comprises a file or codestream 800 containing a header 802 with global parameters including but not limited to the screen area required to display any image layers contained in the file; a block 805, known as the codestream header box, representing the codestream type and channel information; and a sequence of image layers 806-808 encoded using any appropriate method (e.g. RGB, L*a′b′) Alternatively, the codestream header box 805 can be incorporated into the header 802.

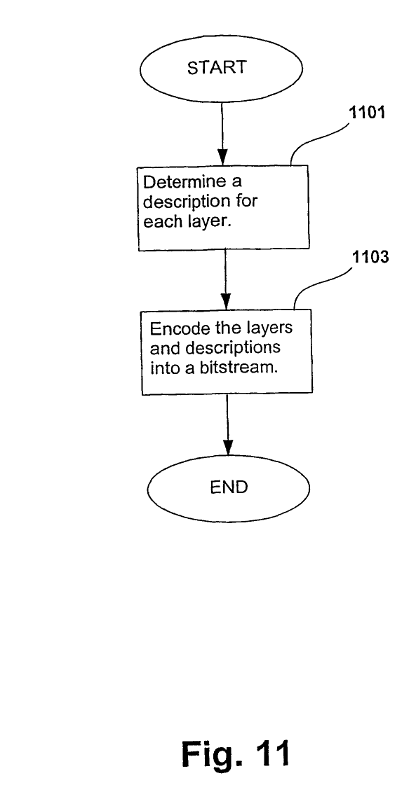

FIG. 11 is a flow chart showing a method of encoding digital images in a coded representation, in accordance with the file format of FIG. 8. The process begins at step 1101 where a description is determined for each of the digital images (layers) in the file 802 (ie. a coded representation). At the next step 1103, the descriptions and the digital images are encodes as a bitstream, wherein at least one of the descriptions is sequentially associated with a plurality of the digital images.

Returning to FIG. 8, the codestream header box 805 lists the type and channel information stored in each of the image layers 806-808 in the file 800. One known type of Codestream Header Box suitable for use with the file format of FIG. 8 is ‘jcsh’ (X‘6A637368’).

The codestream header box 805 contains a number of fields 901-917 as shown in the exploded view of FIG. 8. The code stream header box 805 comprises a codestream description of each codestream associated with each of the image layers 806-808. For example, if a layer has two associated codestreams then the codestream header box 805 will include two codestream descriptions for that particular layer. In accordance the file format of FIG. 8, a codestream description comprises the fields 905 to 917, as shown FIG. 8.

The field 901 referenced by the letters NL contains the number of layers in the file. The field 903 referenced by the letters NC contains the number of codestreams in the file. The field 905 referenced by the letters CTⁱ specifies the type of the codestream for a currently processed codestream i. For example, the codestream i can be encoded according to the Joint Photographics Experts Group (JPEG) standard, Embedded Zerotree Wavelet (EZW) compression, the Set Partitioning in Hierarchical Trees (SPIHT) Algorithm, Scalable Image Compression, or any other suitable image compression method. The field 907 referenced by the letters CSⁱ describes the color specification number of the currently processed codestream i. A value of zero in field 907 specifies that no colour specification is used for the codestream i. The field 909 referenced by the letters PLTⁱ describes the palette number of codestream i. A value of zero in the field 909 specifies that no palette is used for codestream i. The field 911 referenced by the letters LYRⁱ specifies the layer that the codestream i corresponds to. Layers are preferably labeled from 1 representing the first layer 806 to n representing the final layer 808 in the file 800. The field 913 referenced by the letters NLCⁱ specifies the number of logical components in codestream i. The field 915 referenced by the acronym CLT^{ix} defines the nature of the data in the xth logical component in the ith codestream. The field 915 can have one of four values ‘0, 1, 2 or 3’. The meaning associated with each of the values 0-3 of the field 915 is shown in Table 5 below:

TABLE 5

| Type | Meaning |
|---|---|
| 0 | Intensity data that can be associated |
| | directly with a particular channel of a |
| | colour space specification (including |
| | greyscale.) |
| 1 | Opacity data denoted over the range of |
| | 0 . . . 1 |
| 2 | Associated (pre-multiplied) opacity |
| | data. |
| 3 | Relative frequency of the associated |
| | data. This is used principally with |
| | suggested palettes to enable file readers |
| | to make useful decisions when |
| | requantising colours. |

The field 917 referenced by the letters CLA^{ix} contains an index representing the colour channel with which the data of a current layer is associated. The field 917 is preferably a numerical value and is preferably encoded as a 16 bit unsigned integer using network byte order. The value of field 917 associates the xth logical component of the ith codestream with a channel in the specified colour space. Channels in the colour specification are preferably numbered from 1 to m, where m represents the number of channels. For example, if the colour specification is sRGB a value of 1 associates the component with the Red channel. Further, the special value (0) associates a component with all of the colour channels of the specified colour space. The use of (0) with intensity can be used to specify that a codestream contains greyscale samples.

The size of each of the fields 901-917 and the values that each field can be set to, in accordance with the file format of FIG. 8, is shown in Table 6 below:

TABLE 6

| Field | | |
|---|---|---|
| Name | Size (bits) | Value(s) |
| NL | 32 | 1-(2³² − 1) |
| NC | 32 | 1-(2³² − 1) |
| CT | 64 (UUID) | 0-(2⁶⁴ − 1) |
| CS | 32 | 0-(2³² − 1) |
| PLT | 32 | 0-(2³² − 1) |
| LYR | 32 | 1-(2³² − 1) |
| NLC | 32 | 1-(2³² − 1) |
| CLT | 32 | 0-(2³² − 1) |
| CLA | 32 | 0-(2³² − 1) |

The last layer description in the codestream header box 805 is preferably used to describe all remaining layers within the file 800. For example, if the file 800 contained 200 layers, and 3 layer descriptions, then the first two layer descriptions describe the first two layers and the third layer description describes the remaining 198 layers in the file 800. That is, the final unspecified layer is repeated as required Therefore, a number of layers having the same description can be represented by a single description resulting in a more efficient file format as there is no need to have a description corresponding to each layer. Further, the time required by a file reader to process a file encoded in accordance with the file format of FIG. 8 is reduced.

As an example, assume the file 800 contained the following header information as defined by Table 7 below:

TABLE 7

| | | Color |
|---|---|---|
| Layer | Codestream | Information |
| 1 | 1 | RGB |
| 2 | 2 | RGB |
| 2 | 3 | A |
| 3 | 4 | RGBA |
| 4 | 5 | RGBA |

In Table 7, ‘RGB’ represents the RGB colour space and ‘A’ represents the Alpha channel. In accordance with the example of Table 7, the Codestream Header Box 805 would contain the following information, where the bracketed ‘layer description number’ is added to aid explanation:

NL = 4
NC = 5

(Layer description 1)

| | | |
|---|---|---|
| CT¹ = EZW | | |
| CS¹ = 1 | | |
| PLT¹ = 0 | | |
| LYR¹ = 1 | | |
| NLC¹ = 3 | | |
| CLT¹¹ = 0 | CLT¹² = 0 | CLT¹³ = 0 |
| CLA¹¹ = 1 | CLA¹² = 2 | CLA¹³ = 3 |

(Layer description 2)

| | | |
|---|---|---|
| CT² = EZW | | |
| CS² = 1 | | |
| PLT² = 0 | | |
| LYR² = 2 | | |
| NLC² = 3 | | |
| CLT²¹ = 0 | CLT²² = 0 | CLT²³ = 0 |
| CLA²¹ = 1 | CLA²² = 2 | CLA²³ = 3 |
| CT³ = EZW | | |
| CS³ = 1 | | |
| PLT³ = 0 | | |
| LYR³ = 2 | | |
| NLC³ = 1 | | |
| CLT³¹ = 1 | | |
| CLA³¹ = 0 | | |

(Layer description 3)

| | | | |
|---|---|---|---|
| CT⁴ = EZW | | | |
| CS⁴ = 1 | | | |
| PLT⁴ = 0 | | | |
| LYR⁴ = 3 | | | |
| NLC⁴ = 4 | | | |
| CLT⁴¹ = 0 | CLT⁴² = 0 | CLT⁴³ = 0 | CLT⁴⁴ = 1 |
| CLA⁴¹ = 1 | CLA⁴² = 2 | CLA⁴³ = 3 | CLA⁴⁴ = 0 |

Note that layer 4 is not specified and, in accordance with this example, is the same as layer 3. Further, Layer description 2 contains two codestream descriptions as layer 2 comprises two codestreams (i.e. RGB and alpha channel A), as can be seen in Table 7. In the above example of Table 7, when the file 800 is being decoded, a file reader would determine that there are more layers than layer descriptions (i.e. NL=4, layer descriptions=3) and utilise layer description 3 to describe layer 4 (and any remaining layers).

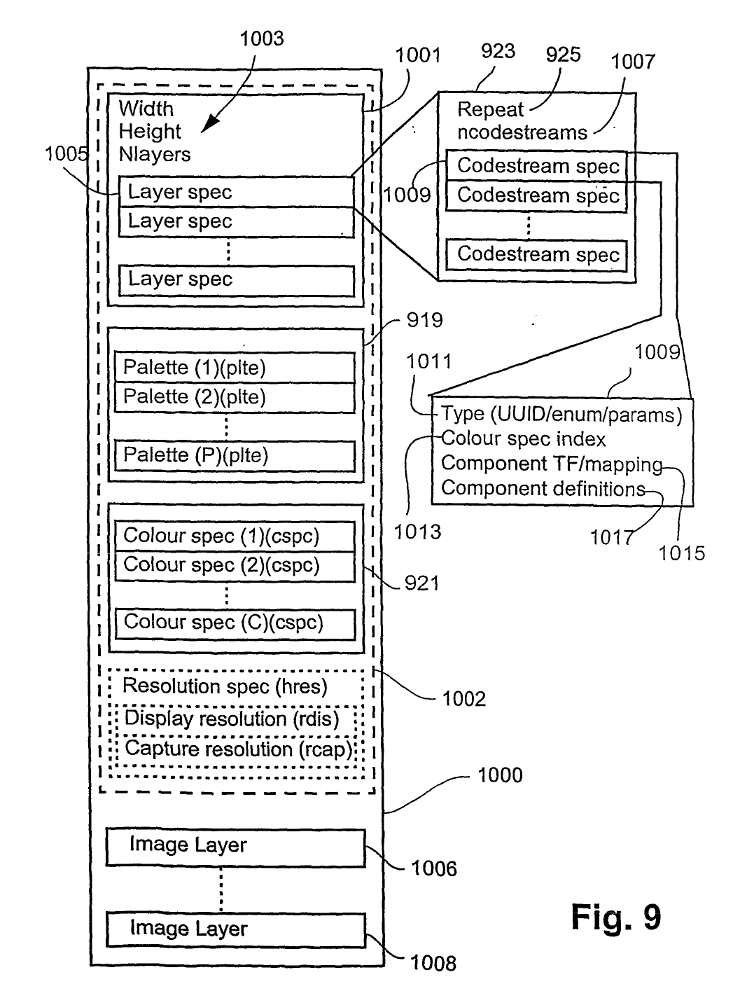

In accordance with still another aspect of the present invention, a header 1002 for a file 1000, comprises at least a box 1001, which contains the width and height of a displayed image as well as the number of layers along with a definition for each of the layers 1006-1008 in the file 1000, as seen in FIG. 9. The box 1001 merges an image size specification 1003, a layer description (eg. 1005) (or layer specification), a component mapping and a component transform list. This makes the header 1002 simple to read. The fields of the box 1001 will be explained in more detail below in accordance with the file format of FIG. 9, a layer description (e.g. 1005) comprises a ‘Repeat’ flag 925, which specifies the number of consecutive layers to which the layer description 1005 applies. The repeat flag can have a value, preferably in the range ‘0-65535’. A repeat flag 925 value of ‘65535’ implies that the particular layer description applies to all remaining layers in the file 1000. The repeat flag 925 allows consecutive groups of layers to have like layer descriptions. Therefore, again a number of layers having the same description can be represented by a single description resulting in a more efficient file format.

In accordance with the file format of FIG. 9, each layer description (e.g 1005) comprises the number of codestreams 1007 and their associated codestream description 1009, as seen in the exploded view of FIG. 9. Each codestream is defined by a compression type 1011, a colour specification 1013, a component transform or mapping 1015 defined by a palette, and a set of component definitions 1017 (type association pairs)—one per component.

In accordance with the file format of FIG. 9, both colour space and palette are specified by an index into the sets of colour specifications and palettes appearing in the header box 921 and 919, respectively, in the header 1002. A component transform or palette lookup is preferably applied to decoded image data as a first step and the resulting pixels are assigned to the colour space defined by a colour spec being used (e.g. sRGB or a space defined by a restricted ICC profile).

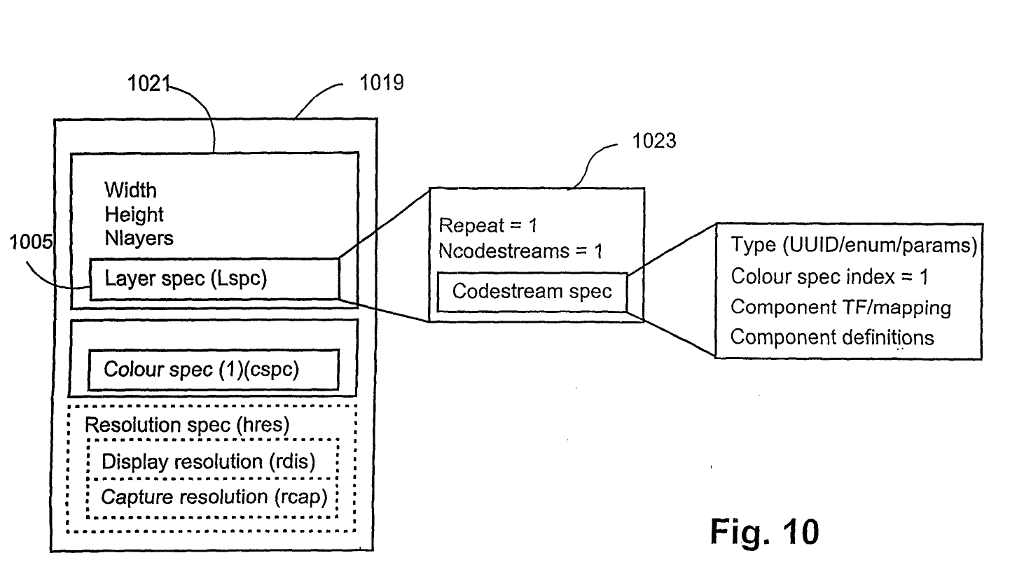

When processing a single layer file with single colour specification and so on, the header 1002 of FIG. 9 would simplify to the header box 1019, as seen in FIG. 10. FIG. 10 shows that for all the additional capabilities facilitated by the header 1002 of FIG. 9, the baseline syntax is not complex.

The fields in the header boxes 1001, 1021, are defined in Table 8 below:

TABLE 8

| Label | Encoding | Descripion |
|---|---|---|
| Width | Unsigned 32 bit integer | The width in pixels of the dis- |
| | in network byte order | play area required to display |
| | | the file |
| Height | Unsigned 32 bit integer | The height in pixels of the |
| | in network byte order | display area required to dis- |
| | | play the file |
| Nlayers | Unsigned 16 bit integer | The number of layers in the |
| | in network byte order | file |
| Layer spec (1) | See table 9 | Specification (ie. Description) |
| | | for one or more layers con- |
| | | tained in the file |

The fields in the layer specification boxes 923, 1023 are defined in Table 9 as follows:

TABLE 9

| Label | Encoding | Description |
|---|---|---|
| Repeat | Unsigned 16 bit | The number of consecutive layers to |
| | integer in network | which this layer specification (ie. |
| | byte order | description) applies. A value of |
| | | 65535 implies all remaining layers in |
| | | the file. Additional layer specifica- |
| | | tions in a file after a box with the |
| | | repeat count will have no effect. |
| Ncodestreams | Unsigned 16 bit | The number of consecutive code- |
| | integer in network | streams in the file that comprise this |
| | byte order | layer. |
| Codestream | See table 10 | Specification (ie. description) for |
| spec (c) | | each of the codestreams comprising |
| | | this layer. |

The fields in the codestream description 1009 are defined in Table 10 as follows:

TABLE 10

| Label | Encoding | Description |
|---|---|---|
| Type | Unsigned 32 bit | The encoding method used with this |
| | integer in network | particular codestream (eg. JPEG, |
| | byte order | EZW, etc). |
| Colour spec | Unsigned 16 bit | Index into the set of colour speci- |
| | integer in network | fications defined in the header box |
| | byte order | |
| Component | See table 11 | The palette or component transform to |
| mapping | | be performed to recover the desired |
| | | colour samples |
| Component | | A sequence of type association pairs |
| definitions | | binding the components to the channels |
| | | of a colour specification. |

The information defined by the component transform/mapping specification 1015 is defined in Tables 11, 12 and 13 as follows:

TABLE 11

| Label | Encoding | Description |
|---|---|---|
| Transform | UUID (ie Universal | 0 = no component transform speci- |
| type | Unique Identifier)/ | fied |
| | enum | 1 = matrix transform |
| | | 2 = gamma adjustment |
| | | 3 = matrix transform and gamma |
| | | adjustment |
| | | 4 = palette |
| Parameters | See tables 12-13 | Parameters applicable to the trans- |
| | | form type. |

TABLE 12

| Label | Encoding | Description |
|---|---|---|
| N | Unsigned 16 bit | The number of components being |
| | integer in network | transformed |
| | byte order | |
| Matrix | Vector of 16.16 fixed | Columnwise scan of a N × N + 1 matrix |
| | point numbers using | where N is the number of components |
| | network byte order | being transformed. The last column of |
| | | this matrix can be used to change the |
| | | zero point for the pixel data. |

TABLE 13

| Label | Encoding | Description |
|---|---|---|
| N | Unsigned 16 bit | The number of components being |
| | integer in network | transformed |
| | byte order | |
| Gamma | 16.16 fixed point | The exponent to be used in the inverse |
| | number using network | transform |
| | byte order | |
| Max | 16.16 fixed point | Value that maxint maps to. |
| | number using network | |
| | byte order | |
| Zero | 16.16 fixed point | Value that zero maps to. |
| | number using network | |
| | byte order | |
| Width | 16.16 fixed point | Width of the linear region around zero. |
| | number using network | Only the positive width is specified |
| | byte order | however gamma should be applied |
| | | symmetrically about zero. |
| Slope | 16.16 fixed point | The slope to use in the linear region. |
| | number using network | |
| | byte order | |

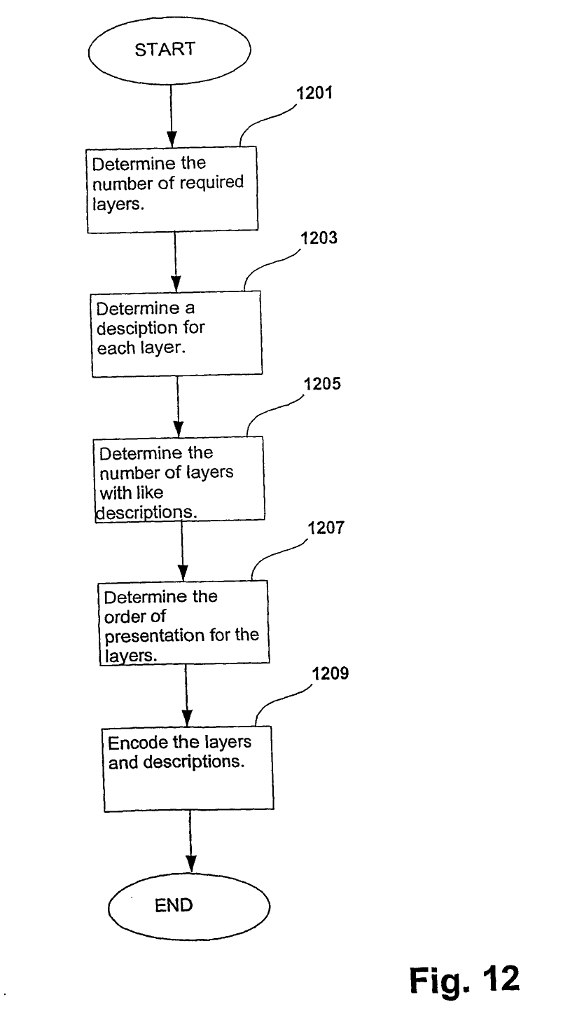

FIG. 12 is a flowchart showing a method of encoding one or more images into the file formats (i.e. coded representations) of FIGS. 8 and 9. The process begins at step 1201 where the number of required layers is determined. At the next step 1203, a layer description is determined for each of layers depending on the type of encoding used for each layer and the number of codestreams in each layer. The process continues at the next step 1205, where the layer descriptions are compared to determine a number of layers with like descriptions. At the next step 1207, an order of presentation of the layers is determined. The process concludes at the next step 1209, where the descriptions and the layers are encoded into either one of the preferred file formats or alternatively, as a bitstream, whereby at least one of the like descriptions are included in the preferred file formats. Further, those layers with the like layer descriptions are placed sequentially at the end of a particular file.

The methods described herein have particular application within the Joint Photographics Experts Group (JPEG) standard. In particular, the JPEG2000, part one standard defines a profile box which contains a list of 4 byte codes describing the standards or profiles within such standards to which the file conforms. However, there are a number of limitations with the JPEG2000 part one standard that are addressed by the methods described herein. Firstly, to ensure that the same 4 byte code is not used to describe separate compatibilities, the codes for the JPEG2000 part one standard must be supplied by a central authority. In using UUIDs which can be generated by independent vendors, the methods described herein ensure that unique codes are used to describe separate compatibilities.

Secondly, the JPEG2000 part one standard lists a group of functionalities with no indication as to which groups of functionalities are mandatory, and which are optional for a codestream. For example, there is no way to define that a complicated color definition combined with a JPEG2000, part two standard codestream is required for a particular codestream transmission. The methods described herein allow for groups of functionalities to be defined.

Thirdly, the reference to a standard or a profile within a standard is too coarse to define specific functionality. Also, such a reference does not allow for overlap between two different standards. For example, JPEG2000 files use restricted ICC profiles. The methods described herein enable the specification of a single piece of functionality, so that anything that understands the file format and can read restricted ICC profiles can read a file formatted in accordance with the methods described herein.

Fourthly, if a file contains a single JPEG2000 part one standard codestream, a header and a color specification, then describing the file in the manner suggested above enables a JPEG2000 compatible reader to read the file without the file having to specify that the file is JPEG2000 compliant.

Fifthly, if a particular file specifies a number of profiles, and not the specific functionality, then a reader may not be able to read future files. If the reader does not understand the future profile, but does understand the specific functionality provided by a profile as described above, then the reader is still able to read the file.

The features within the compatibility box described above can be used throughout a JPEG2000 file. A feature which is referenced elsewhere in a JPEG2000 file, can be identified in the same way using an enumerated value or a UUID. For example, sRGB (defined using the value 16) can used within a color specification and preferably has the same value within the compatibility box.

In addition, the current UUID list box used in the JPEG2000 standard specifies a URL that is used as a link to specify more information regarding a UUID. In accordance with the JPPEG2000, part one standard, these URLs are used to define UUID boxes. The UUID list box can also be used to define UUIDs used to describe functionality in the compatibility box described above.

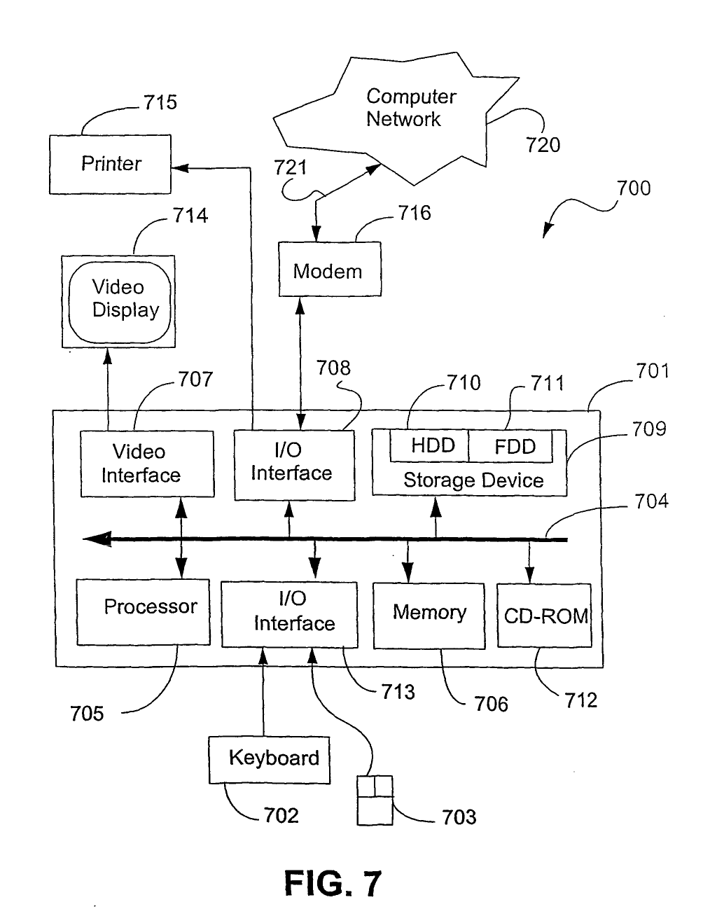

The methods described above are preferably practiced using a conventional general-purpose computer system 700, such as that shown in FIG. 7 wherein the processes of FIGS. 1 to 6 and FIGS. 8 to 11 may be implemented as software, such as an application program executing within the computer system 700. In particular, the methods described above are effected by instructions in the software that is carried out by the computer. The software may be divided into two separate parts; one part for carrying out the described methods, and another part to manage the user interface between the latter and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for encoding digital images in accordance with the embodiments of the invention.

The computer system 700 comprises a computer module 701, input devices such as a keyboard 702 and mouse 703, output devices including a printer 715 and a display device 714. A Modulator-Demodulator (Modem) transceiver device 716 is used by the computer module 701 for communicating to and from a communications network 720, for example connectable via a telephone line 721 or other functional medium. The modem 716 can be used to obtain access to the Internet, and other network systems, such as a Local Area Network (LAN) or a Wide Area Network (WAN).

The computer module 701 typically includes at least one processor unit 705, a memory unit 706, for example formed from semiconductor random access memory (RAM) and read only memory (ROM), input/output (I/O) interfaces including a video interface 707, and an I/O interface 713 for the keyboard 702 and mouse 703 and optionally a joystick (not illustrated), and an interface 708 for the modem 716. A storage device 709 is provided and typically includes a hard disk drive 710 and a floppy disk drive 711. A magnetic tape drive (not illustrated) may also be used. A CD-ROM drive 712 is typically provided as a non-volatile source of data. The components 705 to 713 of the computer module 701, typically communicate via an interconnected bus 704 and in a manner which results in a conventional mode of operation of the computer system 700 known to those in the relevant art. Examples of computers on which the embodiments can be practised include Intel Processor based PC's and compatibles, Sun Sparcstations or alike computer systems evolved therefrom.

Typically, the application program of the preferred embodiment is resident on the hard disk drive 710 and read and controlled in its execution by the processor 705. Intermediate storage of the program and any data fetched from the network 720 may be accomplished using the semiconductor memory 706, possibly in concert with the hard disk drive 710. In some instances, the application program may be supplied to the user encoded on a CD-ROM or floppy disk and read via the corresponding drive 712 or 711, or alternatively may be read by the user from the network 720 via the modem device 716. Still further, the software can also be loaded into the computer system 700 from other computer readable medium including magnetic tape, a ROM or integrated circuit, a magneto-optical disk, a radio or infra-red transmission channel between the computer module 701 and another device, a computer readable card such as a PCMCIA card, and the Internet and Intranets including email transmissions and information recorded on websites and the like. The foregoing is merely exemplary of relevant computer readable mediums. Other computer readable mediums may be practiced without departing from the scope and spirit of the invention.

The method described above can alternatively be implemented in dedicated hardware such as one or more integrated circuits performing the functions or sub functions of described methods. Such dedicated hardware may include graphic processors, digital signal processors, or one or more microprocessors and associated memories.

### Industrial Applicability

It is apparent from the above that the embodiment of the invention is applicable to the computer and data processing industries, and in particular to segments of these industries. Furthermore, embodiments of the invention are also applicable to the advertising and entertainment industries.

The foregoing describes only some embodiments of the present invention, and modifications and/or changes can be made thereto without departing from the scope and spirit of the invention, the embodiments being illustrative and not restrictive.

1. An electronic file comprising:
encoded digital image data; and
an expression representing a plurality of boolean operations, wherein said expression identifies aspects of functionality needed to read said encoded digital image data.

2. The electronic file according to claim 1, wherein said plurality of boolean operations includes at least one bitwise AND operator.

3. The electronic file according to claim 1, wherein said expression represents a series of bitwise OR operations separated by bitwise AND operators.

4. The electronic file according to any one of claims 1 to 3, wherein said expression is coded to include at least one identification flag and an associated mask.

5. The electronic file according to claim 4, wherein said identification flag either specifies an enumerated value or a Universal Unique Identifier.

6. The electronic file according to claim 5, wherein a first bit of said enumerated value is used to indicate that said identification flag specifies a Universal Unique Identifier.

7. A method of encoding an electronic file containing at least one encoded digital image; said method comprising the steps of:
determining an expression for representing a plurality of boolean operations, wherein said expression identifies aspects of functionality needed to read said encoded digital image data; and
adding said expression in a support data area of said electronic file.

8. The method according to claim 7, wherein said plurality of boolean operations includes at least one bitwise AND operator.

9. The method according to claim 7, wherein said expression represents a series of bitwise OR operations separated by bitwise AND operators.

10. The method according to any one of claims 7 to 9, wherein said expression is coded to include at least one identification flag and an associated mask.

11. The method according to claim 10, wherein said identification flag either specifies an enumerated value or a Universal Unique Identifier.

12. The method according to claim 11, wherein a first bit of said enumerated value is used to indicate that said identification flag specifies a Universal Unique Identifier.

13. Apparatus for encoding an electronic file containing at least one encoded digital image, said apparatus comprising:
means for receiving an expression for representing a plurality of boolean operations, wherein said expression identifies aspects of functionality needed to read said encoded digital image data;
means for adding said expression in a support data area of said electronic file.

14. The apparatus according to claim 13, wherein said plurality of boolean operations includes at least one bitwise AND operator.

15. The apparatus according to claim 13, wherein said expression represents a series of bitwise OR operations separated by bitwise AND operators.

16. The apparatus according to any one of claims 13 to 15, wherein said expression is coded to include at least one identification flag and an associated mask.

17. The apparatus according to claim 16, wherein said identification flag either specifies an enumerated value or a Universal Unique Identifier.

18. The apparatus according to claim 17, wherein a first bit of said enumerated value is used to indicate that said identification flag specifies a Universal Unique Identifier.

19. A computer readable medium having a program recorded thereon, said program comprising a plurality of software modules adapted for interactive operation on at least one computer platform, said program adapted to encode an electronic file containing at least one encoded digital image; said program comprising:
code for determining an expression for representing a plurality of boolean operations, wherein said expression identifies aspects of functionality needed to read said encoded digital image data; and
code for adding said expression in a support data area of said electronic file.

20. The computer readable medium according to claim 19, wherein said plurality of boolean operations includes at least one bitwise AND operator.

21. The computer readable medium according to claim 19, wherein said expression represents a series of bitwise OR operations separated by bitwise AND operators.

22. The computer readable medium according to any one of claims 19 to 21, wherein said expression is coded to include at least one identification flag and an associated mask.

23. The computer readable medium according to claim 22, wherein said identification flag either specifies an enumerated value or a Universal Unique Identifier.

24. The computer readable medium according to claim 23, wherein a first bit of said enumerated value is used to indicate that said identification flag specifies a Universal Unique Identifier.

25. A method of encoding digital images in a coded representation, said method comprising the step of:
determining a description for each of said digital images in said coded representation; and
encoding said descriptions and said digital images as a bitstream, wherein at least one of said descriptions is sequentially associated with a plurality of said digital images.

26. The method of claim 25, wherein said description comprises an indicator specifying the number of digital images with which said description is associated.

27. A method of decoding a coded representation of digital images, each of said images having an associated description, said method comprising at least the step of:
outputting said digital images utilising said descriptions, wherein at least one of said descriptions is sequentially associated with a plurality of said digital images.

28. A method of encoding one or more digital images in a coded representation, said method comprising the steps of:
determining the number of digital images in said coded representation;
determining a description for each of said digital images in said coded representation;
comparing said descriptions of said digital images to determine a number of images with like descriptions;
determining an order of presentation of said digital images; and
encoding said set of descriptions and said digital images as a bitstream, wherein only one of said like descriptions are included in said bitstream and wherein those digital images with said like descriptions are placed sequentially at the end of said order.

29. The method according to claim 28, wherein at least one of said like descriptions is associated with a plurality of said digital images.

30. A method of decoding a coded representation of one or more digital images, each of said images having an associated description, said method comprising the steps of:
determining the number of descriptions in said coded representation;
determining the number of digital images in said coded representation; and
outputting said descriptions and said digital images as a bitstream, wherein if said number of digital images is greater than said number of descriptions then a first number of said descriptions is sequentially associated with a second number of said digital images and a remaining one of said descriptions is associated with any remaining digital images.

31. The method according to claim 30, wherein said first and second numbers are the same.

32. A method of encoding digital images in a coded representation, said method comprising the step of:
determining a description for each of said digital images in said coded representation; and
encoding said descriptions and said digital images as a bitstream, wherein at least one of said descriptions is sequentially associated with a plurality of said digital images, and wherein said description comprises an indicator specifying the number of digital images with which said description is associated.

33. The method according to any one of claims 25 to 32, wherein said descriptions include colour information associated with a corresponding image.

34. An apparatus for encoding digital images in a coded representation, said apparatus comprising:
means for determining a description for each of said digital images in said coded representation; and
means for encoding said descriptions and said digital images as a bitstream, wherein at least one of said descriptions is sequentially associated with a plurality of said digital images.

35. The apparatus according to claim 34, wherein said description comprises an indicator specifying the number of digital images with which said description is associated.

36. An apparatus for decoding a coded representation of digital images, each of said images having an associated description, said apparatus comprising:
means for outputting said digital images utilising said descriptions, wherein at least one of said descriptions is sequentially associated with a plurality of said digital images.

37. An apparatus for encoding one or more digital images in a coded representation, said apparatus comprising:
means for determining the number of digital images in said coded representation;
means for determining a description for each of said digital images in said coded representation;
means for comparing said descriptions of said digital images to determine a number of images with like descriptions;
means for determining an order of presentation of said digital images; and
means for encoding said set of descriptions and said digital images as a bitstream, wherein only one of said like descriptions are included in said bitstream and wherein those digital images with said like descriptions are placed sequentially at the end of said order.

38. The apparatus according to claim 37, wherein at least one of said like descriptions is associated with a plurality of said digital images.

39. An apparatus for decoding a coded representation of one or more digital images, each of said images having an associated description, said apparatus comprising:
means for determining the number of descriptions in said coded representation;
means for determining the number of digital images in said coded representation; and
means for outputting said descriptions and said digital images as a bitstream, wherein if said number of digital images is greater than said number of descriptions then a first number of said descriptions is sequentially associated with a second number of said digital images and a remaining one of said descriptions is associated with any remaining digital images.

40. The apparatus according to claim 39, wherein said first and second numbers are the same.

41. An apparatus for encoding digital images in a coded representation, said apparatus:
means for determining a description for each of said digital images in said coded representation; and
means for encoding said descriptions and said digital images as a bitstream, wherein at least one of said descriptions is sequentially associated with a plurality of said digital images, and wherein said description comprises an indicator specifying the number of digital images with which said description is associated.

42. The apparatus according to any one of claims 34 to 41, wherein said descriptions include colour information associated with a corresponding image.

43. A computer readable medium having a program recorded thereon, said program comprising a plurality of software modules adapted for interactive operation on at least one computer platform, said program adapted to encode digital images in a coded representation, said program comprising:
code for determining a description for each of said digital images in said coded representation; and
code for encoding said descriptions and said digital images as a bitstream, wherein at least one of said descriptions is sequentially associated with a plurality of said digital images.

44. The computer readable medium according to claim 43, wherein said description comprises an indicator specifying the number of digital images with which said description is associated.

45. A computer readable medium having a program recorded thereon, said program comprising a plurality of software modules adapted for interactive operation on at least one computer platform, said program adapted to decode a coded representation of digital images, each of said images having an associated description, said program comprising:
code for outputting said digital images utilising said descriptions, wherein at least one of said descriptions is sequentially associated with a plurality of said digital images.

46. A computer readable medium having a program recorded thereon, said program comprising a plurality of software modules adapted for interactive operation on at least one computer platform, said program adapted to encode one or more digital images in a coded representation, said program comprising:
code for determining the number of digital images in said coded representation;
code for determining a description for each of said digital images in said coded representation;
code for comparing said descriptions of said digital images to determine a number of images with like descriptions;
code for determining an order of presentation of said digital images; and
code for encoding said set of descriptions and said digital images as a bitstream, wherein only one of said like descriptions are included in said bitstream and wherein those digital images with said like descriptions are placed sequentially at the end of said order.

47. The computer readable medium according to claim 46, wherein at least one of said like descriptions is associated with a plurality of said digital images.

48. A computer readable medium having a program recorded thereon, said program comprising a plurality of software modules adapted for interactive operation on at least one computer platform, said program adapted to decode a coded representation of one or more digital images, each of said images having an associated description, said program comprising:
code for determining the number of descriptions in said coded representation;
code for determining the number of digital images in said coded representation; and
code for outputting said descriptions and said digital images as a bitstream, wherein if said number of digital images is greater than said number of descriptions then a first number of said descriptions is sequentially associated with a second number of said digital images and a remaining one of said descriptions is associated with any remaining digital images.

49. The computer readable medium according to claim 48, wherein said first and second numbers are the same.

50. A computer readable medium having a program recorded thereon, said program comprising a plurality of software modules adapted for interactive operation on at least one computer platform, said program adapted to encode digital images in a coded representation, said program comprising:
code for determining a description for each of said digital images in said coded representation; and
code for encoding said descriptions and said digital images as a bitstream, wherein at least one of said descriptions is sequentially associated with a plurality of said digital images, and wherein said description comprises an indicator specifying the number of digital images with which said description is associated.

51. The computer readable medium according to any one of claims 43 to 50, wherein said descriptions include colour information associated with a corresponding image.

52. An electronic file comprising:
encoded digital image data; and
an expression representing a plurality of boolean operations, wherein said expression defines a manner in which said encoded digital image data is to be read.
